(19) United States
(12) Patent Application Publication
(10) Pub. No.: US 2025/0175379 A1
(43) Pub. Date: May 29, 2025

(54) ANOMALY DETECTION AND ANOMALY CLASSIFICATION WITH ROOT CAUSE

(71) Applicant: Telefonaktiebolaget LM Ericsson (publ), Stockholm (SE)

(72) Inventors: Paddy Farrell, Offaly (IE); Ashima Chawla, Kildare (IE)

(21) Appl. No.: 18/842,650

(22) PCT Filed: Mar. 1, 2022
(86) PCT No.: PCT/EP2022/055178

§ 371 Date: Aug. 29, 2024

(51) Int. Cl. H04L 41/0631; G06N 3/088; H04L 41/142; H04L 41/16

(52) U.S. Cl. CPC H04L 41/0631; G06N 3/088; H04L 41/142; H04L 41/16

(57) ABSTRACT

Embodiments herein relate, in some examples, to a method performed by a network node for anomaly detection in a radio access network, RAN, in a communication network. The network node (11) obtains KPIs for predicting one or more characteristics of the RAN. The network node (11) further classifies multivariate data related to the obtained KPIs in a multiclass classification incorporated into an unsupervised self-learning neural network model; and provides anomaly classification with a root cause of the classified multivariate data from the unsupervised self-learning neural network model.

### TECHNICAL FIELD

Embodiments herein relate to a network node, and methods performed therein for communication networks. Furthermore, a computer program product and a computer readable storage medium are also provided herein. In particular, embodiments herein relate to anomaly detection, for example, for radio monitoring in a communication network.

### BACKGROUND

In a typical communication network, user equipments (UE), also known as wireless communication devices, mobile stations, stations (STA) and/or wireless devices, communicate via access networks such as a Radio access Network (RAN) to one or more core networks (CN). The RAN covers a geographical area which is divided into service areas or cell areas, with each service area or cell area being served by a radio network node such as an access node e.g. a Wi-Fi access point or a radio base station (RBS), which in some radio access technologies (RAT) may also be called, for example, a NodeB, an evolved NodeB (eNB) and a gNodeB (gNB). The service area or cell area is a geographical area where radio coverage is provided by the radio network node. The radio network node operates on radio frequencies to communicate over an air interface with the UEs within range of the access node. The radio network node communicates over a downlink (DL) to the UE and the UE communicates over an uplink (UL) to the access node.

To understand environment such as radio environment, images, sounds etc. different ways are used to detect certain event, objects or similar. A way of learning is using machine learning (ML) algorithms to improve accuracy. Computational graph models such as ML models, e.g., deep learning models or neural network models, are currently used in different applications and are based on different technologies. A computational graph model is a graph model where nodes correspond to operations or variables. Variables can feed their value into operations, and operations can feed their output into other operations. This way, every node in the graph model defines a function of the variables. Training of these computational graph models is typically an offline process, meaning that it usually happens in datacenters and the execution of these computational graph models may be done anywhere from an edge of the communication network also called network edge, e.g., in devices, gateways or radio access infrastructure, to centralized clouds, e.g., data centers.

Radio networks are influenced by many factors both internal and external to the telecom network and using isolated monitoring metrics on performance is not usually enough to indicate the true cause for failure, to gain a deeper understanding of causation involves a deeper investigation on other influencing factors, factors that are only known to domain experts.

In a communication network today, detecting anomalies is not sufficient to identify with precision the causation of the problem, without including a domain expert.

In network management today key performance indicators (KPI) are used to identify the existence of problems in a network, these KPIs are usually very high level and have no indication of specificity about the problem when seen. The KPIs may be used for rapidly detecting unacceptable performance in the network, enabling the operator to take immediate actions to preserve the quality of the network, thus monitoring and optimizing the radio network performance. Thus, KPIs are measured to monitor the functional aspects of a network from an elevated point of view. For example, functional aspects may comprise monitoring the traffic flows, rates of failure, user connectivity, while at the same time not expressing individual or low-level details about specific resources, ports, links, etc. in the network.

Use of univariate anomaly detection is one approach to study or investigate what may be the cause of a KPI breach, typically this is performed at a counter level where specific counters are targeted, and the univariate anomaly detection algorithm is customized and tuned per counter. However, to identify what counters should be investigated for specific KPI breaches is a manual activity and to tune the algorithm in this case is also manual that can result in a lot of false positive cases, so the use of required post validation steps is required to reduce these false positives.

### SUMMARY

An object of embodiments herein is to provide a mechanism that efficiently and reliably detect anomalies and cause for the anomalies.

According to an aspect the object may be achieved by providing a method performed by a network node for anomaly detection in a RAN in a communication network. The network node obtains KPIs for predicting one or more characteristics of the RAN. The network node further classifies multivariate data related to the obtained KPIs in a multiclass classification incorporated into an unsupervised self-learning neural network model; and provides anomaly classification with a root cause of the classified multivariate data from the unsupervised self-learning neural network model.

According to another aspect the object may be achieved by providing a network node for anomaly detection in a RAN in a communication network. The network node is configured to obtain KPIs for predicting one or more characteristics of the RAN. The network node is further configured to classify multivariate data related to the obtained KPIs in a multiclass classification incorporated into an unsupervised self-learning neural network model; and to provide anomaly classification with a root cause of the classified multivariate data from the unsupervised self-learning neural network model.

It is furthermore provided herein a computer program product comprising instructions, which, when executed on at least one processor, cause the at least one processor to carry out the method above, as performed by the network node. It is additionally provided herein a computer-readable storage medium, having stored there on a computer program product comprising instructions which, when executed on at least one processor, cause the at least one processor to carry out the method above, as performed by the network node.

Embodiments herein interpret anomalies detected by neural networks and offer an explainable solution for a user, such as a stakeholder expert, to better understand the reason behind decisions made by the method.

Embodiments herein incorporate a multiclass classifier into an interpretable anomaly detection framework. The proposed method shows how a multiclass classification incorporated into an unsupervised training mechanism improves issue classification with root cause which are only known to domain experts. Hence, improving automated troubleshooting across anomalies in a multidimensional network data using the proposed architecture.

### BRIEF DESCRIPTION OF THE DRAWINGS

Embodiments will now be described in more detail in relation to the enclosed drawings, in which:

FIG. 1 is a schematic overview depicting a communication network according to embodiments herein;

FIG. 2 is a flowchart depicting a method performed by a network node according to embodiments herein;

FIG. 3 is a MultiClass Classification Architecture according to embodiments herein;

FIG. 4 shows a schematic overview depicting KPI data that are augmented into a graphical image;

FIG. 5 shows a convolutional neural network-based Anomaly Classifier according to embodiments herein;

FIG. 6 is a schematic overview depicting embodiments herein;

FIG. 7 shows embodiments of deployment according to some embodiments herein;

FIG. 8a-8b are block diagrams depicting embodiments of a network node according to embodiments herein;

FIG. 9 schematically illustrates a telecommunication network connected via an intermediate network to a host computer;

FIG. 10 is a generalized block diagram of a host computer communicating via a base station with a user equipment over a partially wireless connection; and

FIGS. 11-14 are flowcharts illustrating methods implemented in a communication system including a host computer, a base station and a user equipment.

### DETAILED DESCRIPTION

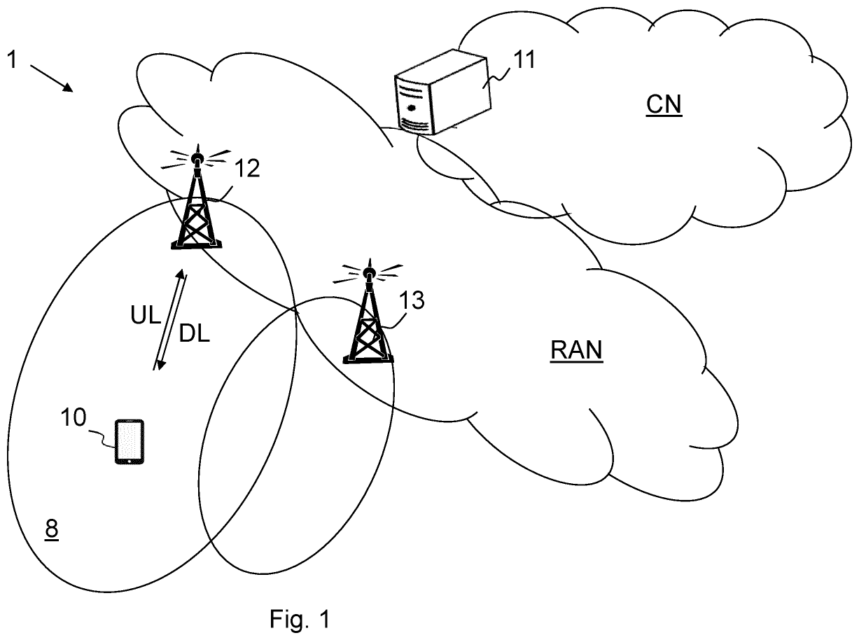

Embodiments herein relate to communication networks in general. FIG. 1 is a schematic overview depicting a communication network 1. The communication network 1 may be any kind of communication network such as a wired communication network or a wireless communication network comprising e.g. a radio access network (RAN) and a core network (CN). The wireless communications network 1 may use one or a number of different technologies, such as Wi-Fi, Long Term Evolution (LTE), LTE-Advanced, Fifth Generation (5G), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in 5G systems, however, embodiments are also applicable in further development of the existing communication systems such as e.g. a WCDMA and LTE.

In the communication network 1, wireless devices e.g. a UE 10 such as a mobile station, a non-access point (non-AP) station (STA), a STA, a user equipment and/or a wireless terminal, communicate via one or more Access Networks (AN), e.g. RAN, to one or more core networks (CN). It should be understood by the skilled in the art that “UE” is a non-limiting term which means any terminal, wireless communication terminal, user equipment, Machine Type Communication (MTC) device, Device to Device (D2D) terminal, IoT operable device, or node e.g. smart phone, laptop, mobile phone, sensor, relay, mobile tablets or even a small base station capable of communicating using radio communication with a network node within an area served by the network node.

The communication network 1 comprises a first radio network node 12 providing e.g. radio coverage over a geographical area, a service area 8, or a first cell, of a radio access technology (RAT), such as NR, LTE, Wi-Fi, WiMAX or similar. The first radio network node 12 may be a transmission and reception point, a computational server, a database, a server communicating with other servers, a server in a server park, a base station e.g. a network node such as a satellite, a Wireless Local Area Network (WLAN) access point or an Access Point Station (AP STA), an access node, an access controller, a radio base station such as a NodeB, an evolved Node B (eNB, eNodeB), a gNodeB (gNB), a base transceiver station, a baseband unit, an Access Point Base Station, a base station router, a transmission arrangement of a radio base station, a stand-alone access point or any other network unit or node depending e.g. on the radio access technology and terminology used. The first radio network node 12 may be referred to as a serving network node wherein the service area 11 may be referred to as a serving cell or primary cell, and the serving network node communicates with the UE 10 in form of DL transmissions to the UE 10 and UL transmissions from the UE 10.

The communication network 1 comprises a second radio network node 13 providing e.g. radio coverage over a geographical area, a second service area 9 or second cell, of a radio access technology (RAT), such as NR, LTE, Wi-Fi, WiMAX or similar. The second radio network node 13 may be a transmission and reception point, a computational server, a database, a server communicating with other servers, a server in a server park, a base station e.g. a network node such as a satellite, a Wireless Local Area Network (WLAN) access point or an Access Point Station (AP STA), an access node, an access controller, a radio base station such as a NodeB, an evolved Node B (eNB, eNodeB), a gNodeB (gNB), a base transceiver station, a baseband unit, an Access Point Base Station, a base station router, a transmission arrangement of a radio base station, a stand-alone access point or any other network unit or node depending e.g. on the radio access technology and terminology used. The second radio network node 12 may be referred to as a neighbouring node. The first and second network nodes may be part of a same logical node, or different nodes. Thus, the first radio network node may alternatively be denoted as first radio network function and the second radio network node may be denoted as second radio network function.

The communication network 1 comprises a network node 11 such as a central network node for handling data, i.e., detecting anomalies from one or more radio network nodes in the communication network. For example, the network node may be a computational server, a database, a server communicating with other servers, a server in a server park, or similar. The network node 11 may be a stand-alone server or a distributed node over one or more computational arrangements. The network node 11 may comprise a computational graph model such a neural network (NN) e.g., a deep neural network (DNN), for calculating characteristics of the RAN. The network node 11 may alternatively be denoted as central network function. Embodiments herein concern computational graph model training such as ML model training, for example. Thus, the computational graph model may be a machine learning (ML) model such as a NN e.g., a DNN or a convolutional neural network (CNN). The training may be performed in a centralized or decentralized manner.

Given a fixed time interval for the analysis, which fixed time may also be referred to as Reporting Output Period (ROP), root cause analysis (RCA) counters are able to measure the number of times that a certain event occurs, such as the number of handovers properly carried out, the number of allocations success for a particular transmission channel or the number of failure events as an example dropped-calls, the rate of accessibility to a particular services, type of modulation, signal strength, signal quality and so on.

Each RCA counter, usually, determines the amount or number of occurrences related to a single event, therefore they must be analysed and grouped together in order to build a useful Key Performance Indicator (KPI). As an example, if one is interested to monitor dropped calls one may consider, or take into account, several possible causes of failure such as radio interface, backbone, base station hardware, codes lub interface, and so on.

It is herein proposed a computational graph model training method, for example, for RAN managing use cases taking the prediction of the KPIs into account. KPIs are used to identify the existence of problems in a network, these KPIs have no indication of specificity about the problem when seen.

As telecom networks are high-dimensional, it becomes imperative to support massive numbers of coexisting network attributes and to provide an interpretable and explainable Artificial Intelligence (XAI) anomaly detection system. Most state-of-the-art techniques tackle the problem of detecting network anomalies with high precision, but the models don't provide an interpretable solution. This makes it hard for operators to adopt the given solutions. Embodiments herein tackle one or more of these problems by providing a multivariate anomaly classifier and/or a multivariate sequential anomaly classifier. The proposed workflow model improves model interpretability by designing an end-to-end data driven Artificial Intelligence (AI)-based framework which includes in some embodiments a Machine to Machine (M2M) Feedback loop. The incorporation of the feedback loop deals with the problem of high false positives in the unsupervised trained model making it more robust.

Embodiments herein interpret anomalies detected by the method and offer an explainable solution for stakeholder experts to better understand the reason behind decisions made by a model. It is further incorporated a multiclass classifier into an interpretable anomaly detection framework. The proposed algorithm shows how a multiclass classification incorporated into an unsupervised training mechanism improves issue classification with root cause which are only known to domain experts. Hence, improving automated troubleshooting across anomalies in a multidimensional network data using embodiments herein.

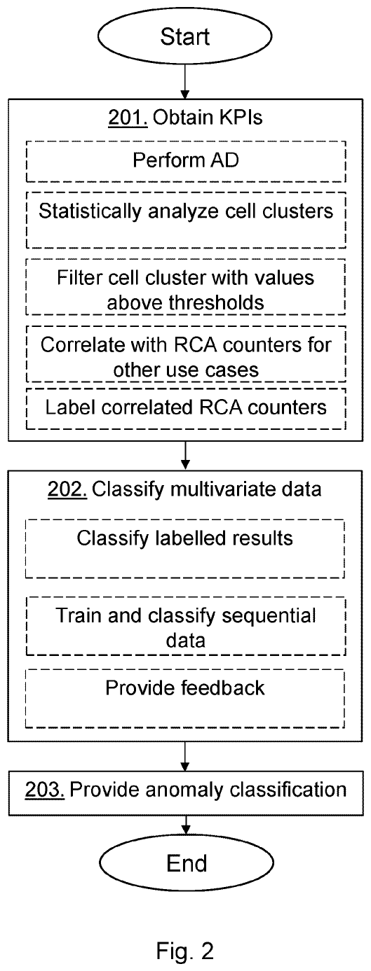

The method actions performed by the network node 11 for anomaly detection, for example, handling anomaly detection, in the RAN in the communication network according to embodiments will now be described with reference to a flowchart depicted in FIG. 2. The actions do not have to be taken in the order stated below, but may be taken in any suitable order. Actions performed in some embodiments are marked with dashed boxes.

Action 201. The network node 11 obtains KPIs for predicting one or more characteristics of the RAN. These KPIs may be defined as RAN predefined KPIs.

For example, the network node 11 may perform anomaly detection (AD) for detecting anomalous KPIs over different time periods such as trend and seasonal components.

Furthermore, the network node 11 may statistically analyse one or more cell clusters, by analysing anomalous behavior pattern of the detected anomalous KPIs, to filter one or more Root Cause Analysis (RCA) counters to analyse the RCA counters with respect to KPIs of detected anomalous KPIs. For example, the network node 11 may identify cell IDs by analysing anomalous behaviour pattern of the cell clusters. Thus, the network node 11 may filter pre-defined RCA counters to analyse them with respect to KPIs. Thus, RCA counters and KPIs are correlated with one another.

The network node 11 may further filter the one or more cell clusters with RCA counter values and KPIs above thresholds to identify RCA counters of the KPIs, thus, identifying pairs of RCA counters and KPIs for the values that crossed or reached the thresholds.

Furthermore, the network node 13 may, once the RCA counters with respect to KPIs have been identified, correlate, the RCA counters, with RCA counters identified for other use cases. For example, the network node 13 may correlate the RCA counters with RCA counters of other use cases to result in correlated RCA counters. For example, to filter out RCA counters for a number of use cases.

The network node 13 may then label the correlated RCA counters in order to map relevant groupings of correlated anomalous KPIs with a set of related RCA counters aligned with a preferred performance outcome. Grouping here refers to the previous correlating the KPI anomalies with the set of related RCA counters. Preferred performance outcome may be related to below a set congestion due to a high level of subscribers or similar.

Action 202. The network node 13 classifies multivariate data related to the obtained KPIs in a multiclass classification incorporated into an unsupervised self-learning neural network model. Thus, providing, for example, an end-to-end process providing a self-learning Deep Learning based model. The unsupervised self-learning neural network model does not include any human intervention to supervise the training.

The network node 13 may classify labelled results indicating multivariate anomalies to be identified as root causes by indicating RCA counters that are contributing factors. Thus, the RCA counters are considered as causes. There is a mapping or more specifically a binary labelling has been extended to a multiclassifier model.

The network node 13 may, additionally or alternatively, train sequential data and classify the sequential data into root cause classes using multiclass anomaly classifier. That is, the network node 13 may train the sequential data, e.g., input as KPI data over several ROPs, for example, having different trend and patterns, over time, and may classify the sequential data into multiclass for RCA counters. Thus, classified root cause class here is a result of time sequence of individual RCA counters.

Thus, embodiments herein provide network operators with actionable insights which enables a deeper investigation of influencing RCA counters and combinations.

The network node 11 may further provide feedback to the statistical analysing, see action 201, until a detection rate reaches or crosses a threshold set by an operator. Such as threshold may be set based on sensitivity for errors or a margin. Preferably, the feedback is provided to reduce input space of the unsupervised self-learning neural network model. The feedback may provide a reduction of unimportant features, i.e., RCA counters and/or KPIs, which narrows an overall input space to the unsupervised self-learning neural network model and may also refine the magnitude of the impact the remaining features have individually. For example, the network node 11 may provide feedback, indications of RCA counters, to the statistical analysis; and, in one embodiment, the unsupervised self-learning neural network model is trained until it reaches an equilibrium point with a minimal loss margin. With margin it is meant that the trained neural network model is optimized to reduce the loss between the actual and predicted target. For example, the network node may provide feedback such as relevant set of RCA counters and KPIs and remove unimportant features which add false positives to the model performance. Thus, the network node 11 provides feedback to make the model more robust and less prone to errors. A feedback loop providing the feedback may become crucial in mitigating against false positives and, in one embodiment, the unsupervised self-learning neural network model may be trained until loss curve reaches the equilibrium point, i.e., the error margin between false true positives becomes consistent. The equilibrium point may indicate that the model is fully trained and generalized well. In an alternative embodiment, instead of training the self-learning neural network model until it reaches an equilibrium point, the method may be based on providing feedback to the statistical analysis to reduce the input space of the unsupervised self-learning neural network model until a detection rate crosses a threshold set by an operator, which may be different from the equilibrium. The advantage of training the model until a detection rate crosses a threshold over a solution relying on the model reaching equilibrium point is that the threshold may be set at a level at which the model is trained enough and generalized well enough to allow for anomaly detection in shorter time and at lower consumption of processing resources. In one embodiment the operator may define the threshold at the equilibrium point.

Action 203. The network node 13 provides anomaly classification with a root cause of the classified multivariate data from the unsupervised self-learning neural network model. Thus, the network node 11 provides RCA counters that are responsible for producing the anomalous behaviour in the network. This is done with respect to KPIs. Thus, the outcome of the method may be a selected list of (important) RCA counters among an entire list which shows an anomalous pattern.

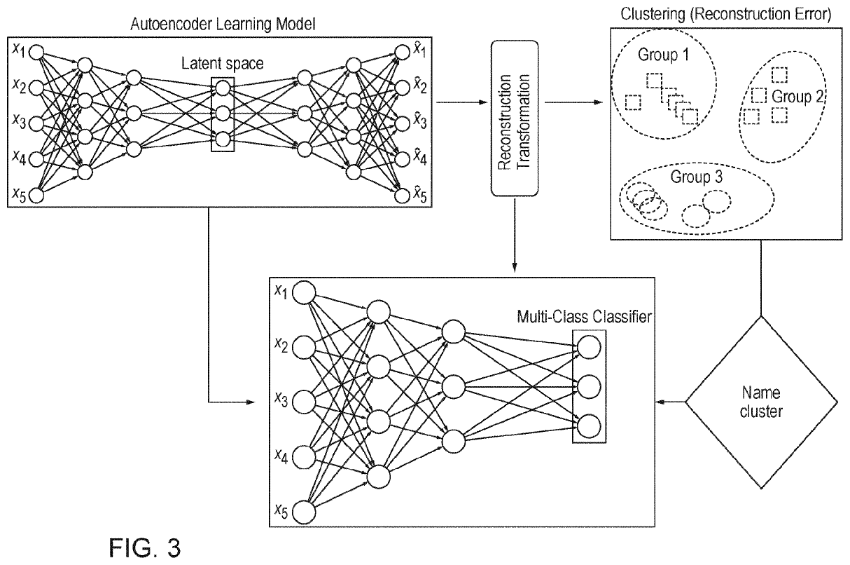

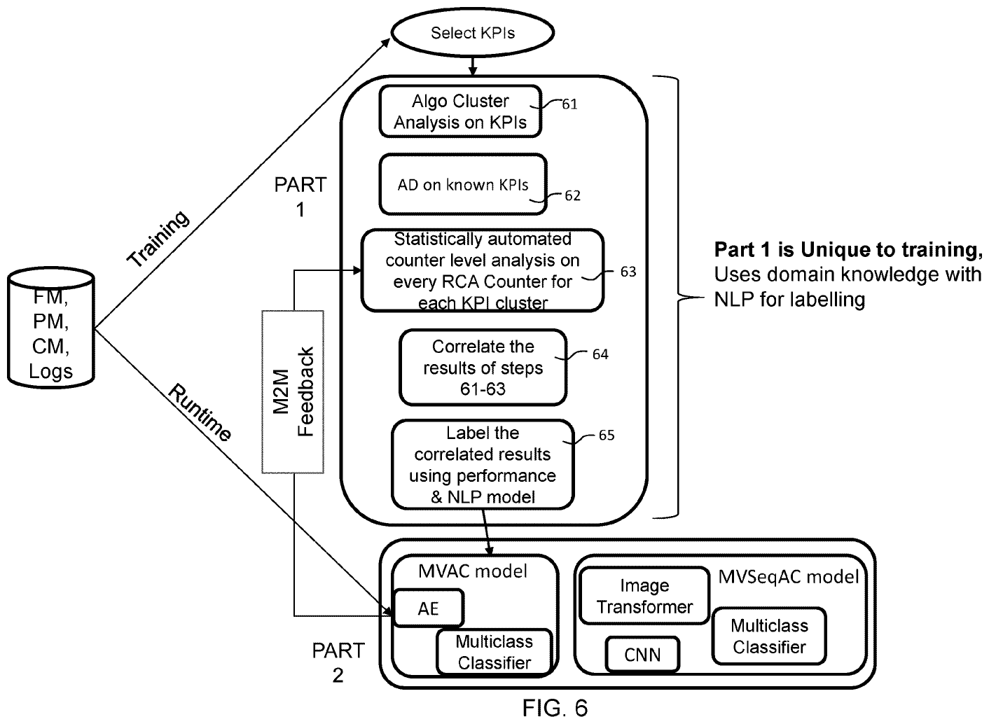

FIG. 3 shows a MultiClass Classification Architecture according to embodiments herein, where autoencoders are used to leverage their latent space and reconstruction error matrix to cluster and classify the anomalies in the communication network. This helps in identifying issues, also referred to as root causes, which are hidden in the communication network and caused due to combination of multiple events happening at the same time. Thus, FIG. 3 shows an autoencoder-based model which takes KPIs and RCA counters as input, tries to reconstruct them, and then uses labels from part 1 of the process, see FIG. 6, to train and classify into different categories using a multi-classifier, see actions 202 and 203.

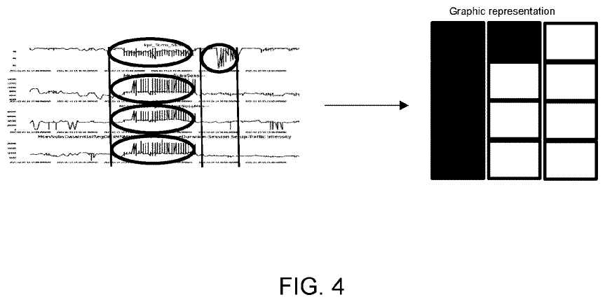

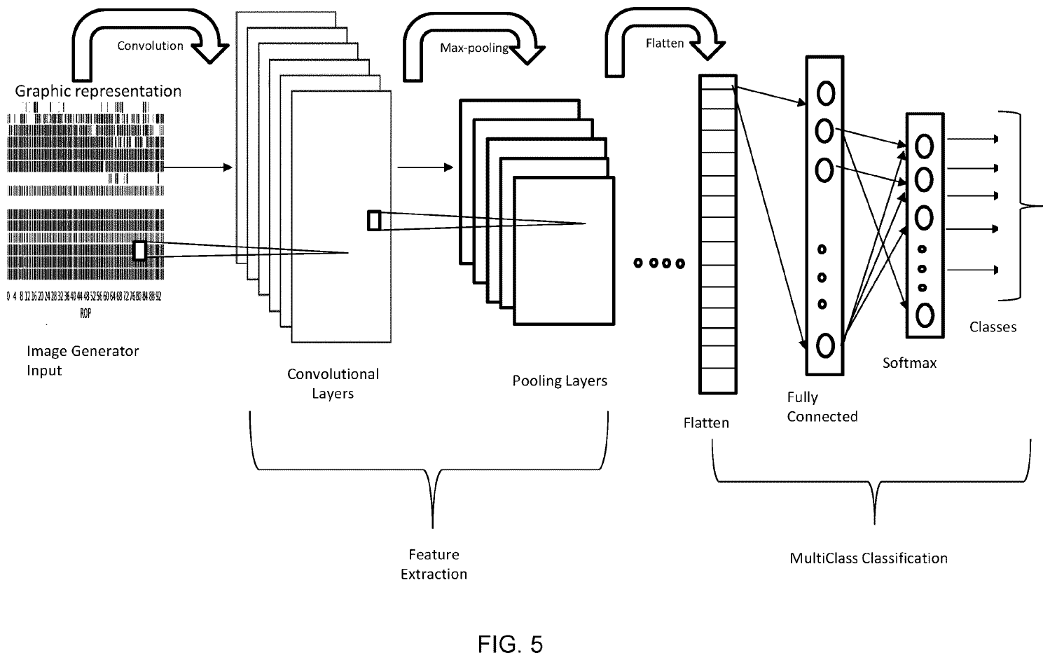

In use case two in action 202, a Multivariate Sequential Anomaly Classifier is used. In FIG. 4 it is shown how KPI data is illustrated in a 2D Image representation. Thus, FIG. 4 shows how the Convolutional Neural Network (CNN) concept is leveraged and where the KPI data are augmented over several ROPs and across multiple KPIs into a graphical image. These KPI data once converted into a 2D space such as the graphical image, is then fed into a neural network model and these multivariate sequential issues are then further classified into root cause classes as shown in FIG. 5. FIG. 5 shows a CNN based Anomaly Classifier performing the action of training the sequential data and classifying the sequential data into root cause classes using multiclass anomaly classifier. Thus, first in an image generator input, the KPI data across several ROPs are fed to convert that into a 2-Dimensional graphical image.

Neurons in the first convolutional layers are not connected to every single pixel in the input. Instead, they are connected to pixels in their respective fields. This type of architecture allows to concentrate on the specific features in the hidden layers.

Then, pooling layer reduces the input image in order to reduce the computational load, the memory usage and the number of parameters to limit the risk of overfitting. As shown in FIG. 5, each neuron in the pooling layer is connected to the outputs of a limited number of neurons from the previous layer, located within a small rectangular receptive field.

Flattening in CNN is to convert data into 1-dimensional array to create a feature vector array as an input to fully-connected image classifier model. In a final activation function, softmax calculates the probability distribution and classifies the images into different classes.

FIG. 6 shows an example according to embodiments described herein. The method is divided into two parts. A first part being a training of the method that uses domain knowledge with natural language processing (NLP) for labelling. Input may be data concerning configuration management (CM), performance management (PM), fault management (FM) and other logs. Embodiments herein comprise one or more of the following:
61) Performing Agglomerative Clustering operation on one or more time series based KPIs to capture the trends, seasonal and periodic patterns. This distinguishes and identifies the set of worst performing clusters to detect anomalous KPIs. Thus, performing a clustering operation on one or more KPIs into at least two clusters of KPIs.
62) Performing anomaly detection (AD) for detecting anomalous KPIs over different trend and seasonal components.
63) Statistically analysing the top identified worst performing cell clusters to identify one or more RCA counters. Here, worst performing cell cluster to perform root cause analysis means the values are either too high or too low with respect to their normal values. For example, statistically analysing RCA counters of the detected anomalous KPIs.
64) Filtering the clusters of worst performing cells with respect to the target KPI and RCA counter and identifying RCA counters of the KPIs. Once the RCA counters with respect to KPIs have been identified, actions above are performed for another use case identification. Such use cases may be UE Sync Issues, Coverage Issues, RLF issues. Thus, correlating RCA counters indicating a respective anomaly with the detected KPIs.
65) Labelling the correlated RCA counters to map the relevant groupings aligned with a preferred performance.

It is further shown in the second part of FIG. 6 the actions of:
Classifying the labelled results indicating multivariate anomalies indicating the contributing individual counters to be identified as the root causes. The interpretability framework here provides network operators with the actionable insights which enables a deeper investigation of influencing counters and combinations. This may be performed in a Multivariate Anomaly Classifier (MVAC) model comprising a multiclass classifier and an anomaly evaluator (AE).
Classifying the sequential data into root cause classes using multiclass anomaly classifier. This may be performed in a Multivariate Sequential Anomaly Classifier (MVSeqAC) model comprising an image transformer, see FIG. 4, an CNN, and a multiclass classifier.
Providing feedback to the statistical analysis to make the unsupervised self-learning neural network model more robust and less prone to errors, i.e. reducing false positives. Here, the internal M2M feedback loop becomes a part of the unsupervised self-learning neural network model which further refines the probability of Root Cause vs basic correlation or victimization that happened as a result. Thus, an entire end-to-end process results in pointing to the relevant set of causes which defines the root cause analysis as compared to the basic correlations which might be false-positive and not holds true.

It should be noted that MVAC and MVSeqAC models may be used for different use cases that use the data preparation method from the first part and this data is further fed into their respective classifier model.

Deep Learning (DL) algorithms may be used herein and then these DL algorithms are combined with elements in the flowchart in FIG. 6. For example, actions 63-65 together with Image transformer and M2M Feedback enable an efficient manner of obtaining the root cause.

Embodiments herein identify a set of multivariate anomalous features responsible for network failure with their interpretation, and perform classification to explain both root cause and localization. Localization here means to find the relevant set of root causes and classifying them into their relevant set of categories.

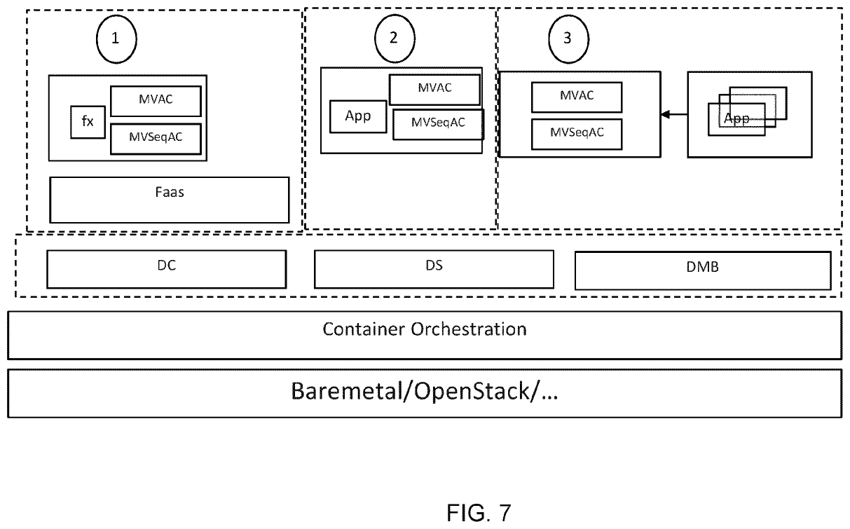

FIG. 7 shows an overview of an open stack architecture comprising: Container Orchestration, e.g., K8S, Cattle, Swarm; Distributed Computing (DC), e.g., Dask, Ray, Apache Spark; Distributed Storage (DS), e.g., Amazon S3, MinIO; and Distributed Message Bus (DMB), e.g., Apache Kafka.

In a first deployment 1, MVAC and MVSeqAC are available with every function as a service (FaaS) function (fx) deployed in a serverless FaaS system. This option of deployment can be for both cloud and near edge platforms where functions are built with MVAC and MVSeqAC as additional functionalities are available with them. Thus, MVAC & MVSeqAC using DNN in PM Data available with every Faas.

In a second deployment 2, MVAC and MVSeqAC are available as side-car containers with an application. This option of deployment can be for both cloud and near edge platform applications. Applications that prefer to do a life cycle management of MVAC and MVSeqAC like it does for the application prefers this architecture.

In a third deployment, MVAC and MVSeqAC are available as pod with their own scaling and security. This option is the only option for edge devices to get MVAC and MVSeqAC functionalities as they are resource-constrained. Also, this option is available for near edge and cloud as alternative architecture where applications and functions want to use a common pod rather than having MVAC and MVSeqAC as a side car container.

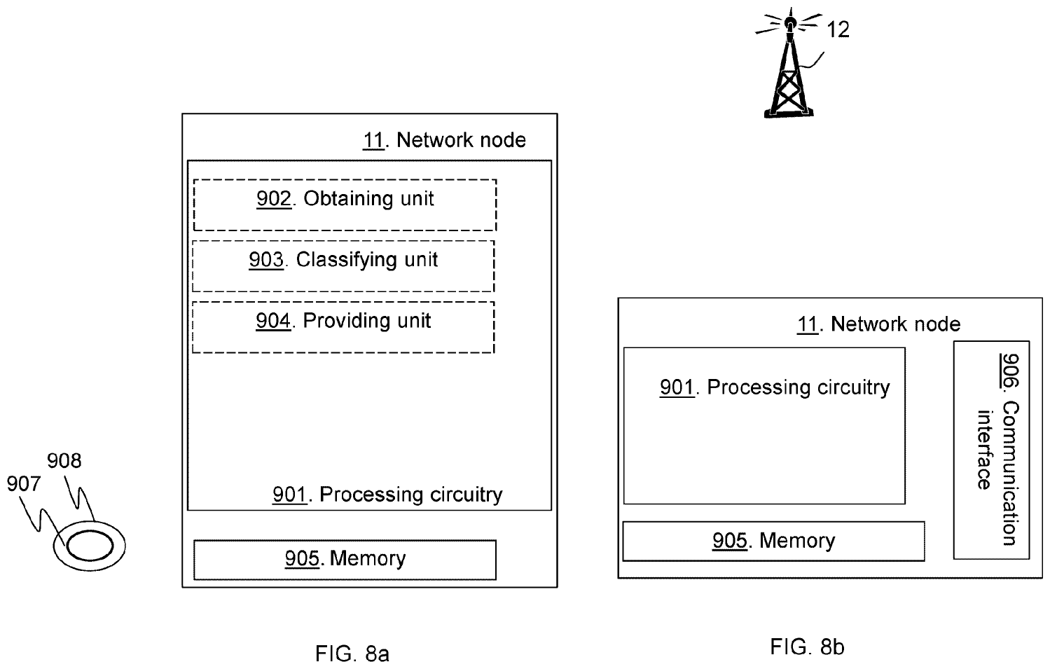

FIGS. 8a and 8b are block diagrams depicting the network node 11, in two embodiments, for handling anomaly detection in the RAN in the communication network according to embodiments herein.

The network node 11 may comprise processing circuitry 901, e.g., one or more processors, configured to perform the methods herein.

The network node 11 may comprise an obtaining unit 902, e.g., a receiver or a transceiver. The network node 11, the processing circuitry 901, and/or the obtaining unit 902 is configured to obtain KPIs for predicting one or more characteristics of the RAN.

The network node 11, the processing circuitry 901, and/or the obtaining unit 902 may be configured to obtain the KPIs by:
detecting the anomalous KPIs over the one or more time periods;
statistically analysing the one or more clusters of cells of the detected anomalous KPIs, by analysing anomalous behavior pattern of the detected anomalous KPIs, to filter the one or more RCA counters to analyse the one or more RCA counters with respect to KPIs;
filtering the one or more cell clusters with the RCA counter values and the KPIs above thresholds to identify the RCA counters of the KPIs.

The network node 11 may comprise a classifying unit 903. The network node 11, the processing circuitry 901, and/or the classifying unit 903 is configured to classify the multivariate data related to the obtained KPIs in the multiclass classification incorporated into the unsupervised self-learning neural network model.

The network node 11, the processing circuitry 901, and/or the classifying unit 903 may be configured to classify the multivariate data by
classifying the labelled results indicating the multivariate anomalies to be identified as the root causes by indicating the RCA counters that are contributing factors; and/or
training sequential data and classifying the sequential data into root cause classes using multiclass anomaly classifier.

The network node 11 may comprise a providing unit 904., e.g., a transmitter and/or transceiver. The network node 11, the processing circuitry 901, and/or the providing unit 904 is configured to provide anomaly classification with the root cause of the classified multivariate data from the unsupervised self-learning neural network model.

The network node 11, the processing circuitry 901, and/or the classifying unit 903 may be configured to classify the multivariate data by
once the RCA counters with respect to KPIs have been identified, correlating said identified RCA counters with the RCA counters identified for other use cases; and
labelling the correlated RCA counters to map relevant groupings of correlated anomalous KPIs with a set of related RCA counters aligned with a preferred performance outcome.

The network node 11, the processing circuitry 901, and/or the classifying unit 903 may be configured to classify the multivariate data by
providing the feedback to the statistical analysing until the detection rate crosses the threshold set by the operator. For example, to reduce input space of the unsupervised self-learning neural network model.

The network node 11 further comprises a memory 905. The memory comprises one or more units to be used to store data on, such as computational graph model, local data, sub-graph, parameters, values, RCA counters, KPIs, operational parameters, applications to perform the methods disclosed herein when being executed, and similar. Thus, embodiments herein may disclose a network node for handling data in the communication network, wherein the network node comprises processing circuitry and a memory, said memory comprising instructions executable by said processing circuitry whereby said network node is operative to perform any of the methods herein. The network node 11 comprises a communication interface 906 comprising, e.g., a transmitter, a receiver, a transceiver and/or one or more antennas.

The methods according to the embodiments described herein for the network node 11 are respectively implemented by means of e.g. a computer program product 907 or a computer program, comprising instructions, i.e., software code portions, which, when executed on at least one processor, cause the at least one processor to carry out the actions described herein, as performed by the network node 11. The computer program product 907 may be stored on a computer-readable storage medium 908, e.g., a universal serial bus (USB) stick, a disc or similar. The computer-readable storage medium 908, having stored thereon the computer program product, may comprise the instructions which, when executed on at least one processor, cause the at least one processor to carry out the actions described herein, as performed by the network node 11. In some embodiments, the computer-readable storage medium may be a non-transitory or a transitory computer-readable storage medium.

In some embodiments a more general term “network node” is used and it can correspond to any type of radio network node or any network node, which communicates with a wireless device and/or with another network node. Examples of network nodes are NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, Remote Radio Unit (RRU), nodes in distributed antenna system (DAS), core network node e.g. Mobility Switching Centre (MSC), AMF, Mobility Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT) etc.

In some embodiments the non-limiting term wireless device or user equipment (UE) is used and it refers to any type of wireless device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However, the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

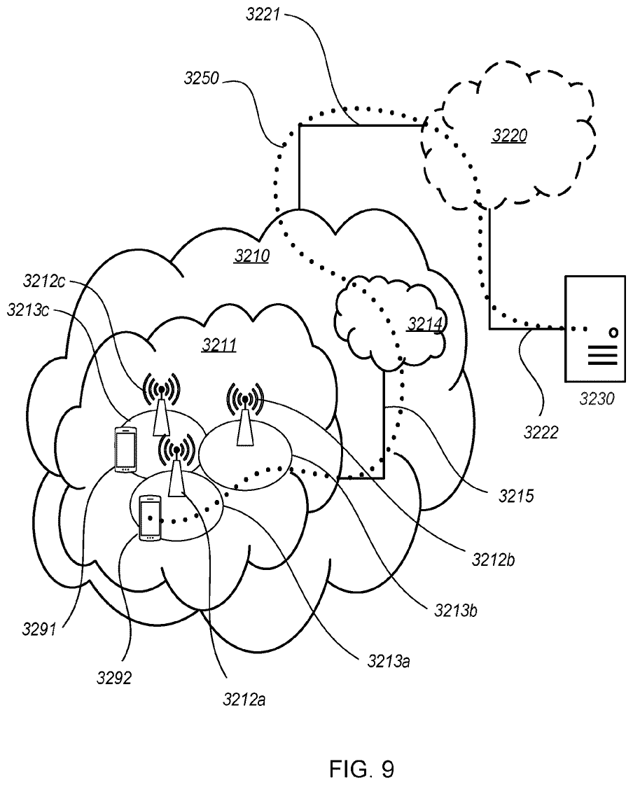

With reference to FIG. 9, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 9 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

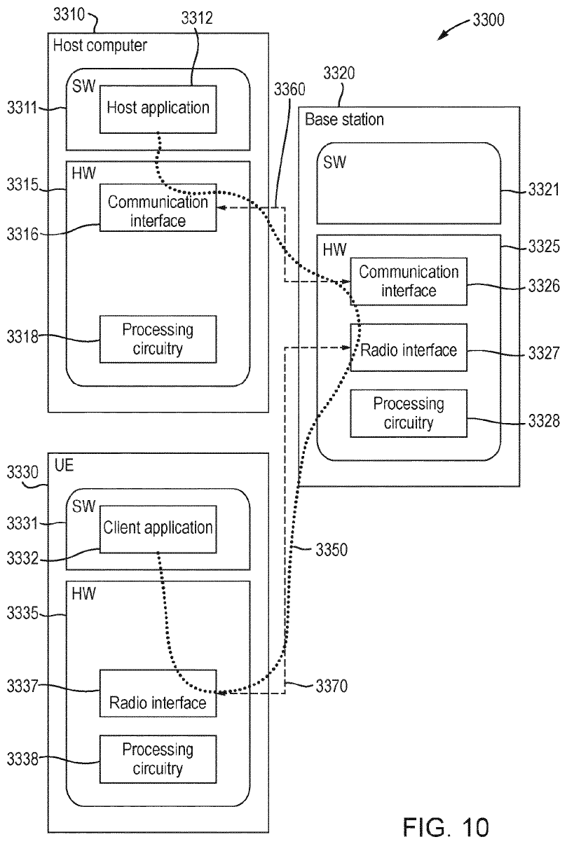

Example implementations, in accordance with an embodiment, of the UE, base station and host computer discussed in the preceding paragraphs will now be described with reference to FIG. 10. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 10) served by the base station 3320. The communication interface 3326 may be configured to facilitate a connection 3360 to the host computer 3310. The connection 3360 may be direct or it may pass through a core network (not shown in FIG. 10) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 10 may be identical to the host computer 3230, one of the base stations 3212a, 3212b, 3212c and one of the UEs 3291, 3292 of FIG. 9, respectively. This is to say, the inner workings of these entities may be as shown in FIG. 10 and independently, the surrounding network topology may be that of FIG. 9.

In FIG. 10, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance of OTT services delivered over the RAN network illustrated in one embodiment in FIG. 9 since the method herein may model the RAN in a more accurate manner and improve anomaly detection in the RAN, and thereby may provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

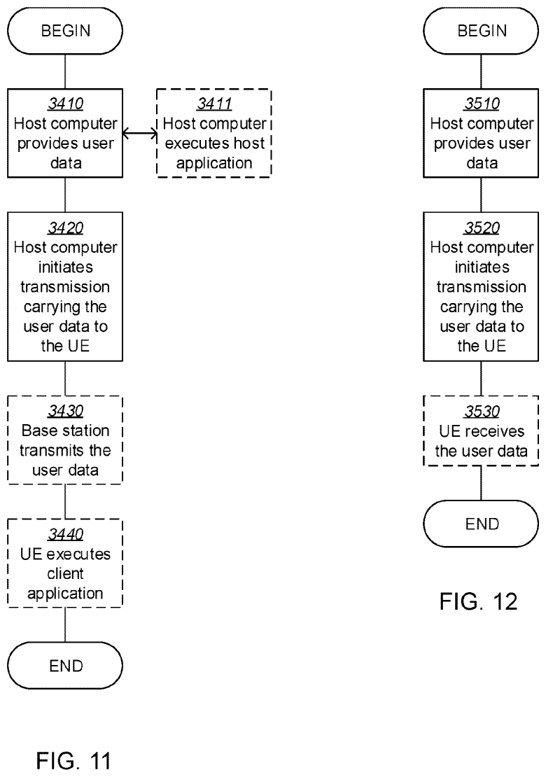

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

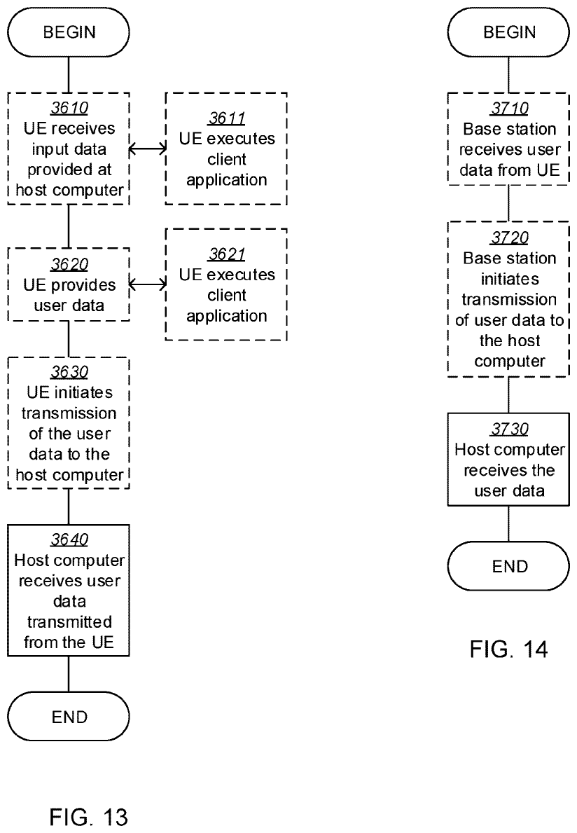

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a network node (11) for anomaly detection in a radio access network, RAN, in a communication network, the method comprising:
obtaining (201) key performance indicators, KPI, for predicting one or more characteristics of the RAN;
classifying (202) multivariate data related to the obtained KPIs in a multiclass classification incorporated into an unsupervised self-learning neural network model; and
providing (203) anomaly classification with a root cause of the classified multivariate data from the unsupervised self-learning neural network model.

2. The method according to claim 1, wherein classifying (202) the multivariate data comprises
classifying labelled results indicating multivariate anomalies to be identified as the root causes by indicating root cause analysis, RCA, counters that are contributing factors; and/or
training sequential data and classifying the sequential data into root cause classes using multiclass anomaly classifier.

3. The method according to claim 1, wherein obtaining (201) the KPIs comprises
detecting anomalous KPIs over one or more time periods;
statistically analysing one or more clusters of detected anomalous KPIs, by analysing anomalous behavior pattern of the detected anomalous KPIs;
filtering the one or more clusters with root cause analysis, RCA, counter values and KPIs above thresholds to identify RCA counters of the KPIs.

4. The method according to claim 3, wherein obtaining (201) the KPIs further comprises
once the RCA counters with respect to KPIs have been identified, correlating said identified RCA counters with RCA counters identified for other use cases; and
labelling the correlated RCA counters to map relevant groupings of correlated anomalous KPIs with a set of related RCA counters aligned with a preferred performance outcome.

5. The method according to claim 3, wherein classifying (202) the multivariate data comprises
providing feedback to the statistical analysing until a detection rate crosses or reaches a threshold set by an operator.

6. A computer program product comprising instructions, which, when executed on at least one processor, cause the at least one processor to carry out a method according to claim 1, as performed by the network node.

7. A computer-readable storage medium, having stored thereon a computer program product comprising instructions which, when executed on at least one processor, cause the at least one processor to carry out a method according to claim 1 as performed by the network node.

8. A network node (11) for handling anomaly detection of a radio access network, RAN, in a communication network, wherein the network node is configured to
obtain key performance indicators, KPI, for predicting one or more characteristics of the RAN;
classify multivariate data related to the obtained KPIs in a multiclass classification incorporated into an unsupervised self-learning neural network model; and
provide anomaly classification with a root cause of the classified multivariate data from the unsupervised self-learning neural network model.

9. The network node (11) according to claim 8, wherein the network node is configured to classify the multivariate data by
classifying labelled results indicating multivariate anomalies to be identified as the root causes by indicating root cause analysis, RCA, counters that are contributing factors; and/or
training sequential data and classifying the sequential data into root cause classes using multiclass anomaly classifier.

10. The network node (11) according to claim 8, wherein the network node is configured to obtain the KPIs by:
detecting anomalous KPIs over one or more time periods;
statistically analysing one or more clusters of detected anomalous KPIs, by analysing anomalous behavior pattern of the detected anomalous KPIs;
filtering the one or more clusters with root cause analysis, RCA, counter values and KPIs above thresholds to identify RCA counters of the KPIs.

11. The network node (11) according to claim 10, wherein the network node is configured to obtain the KPIs by:
once the RCA counters with respect to KPIs have been identified, correlating said identified RCA counters with RCA counters identified for other use cases; and
labelling the correlated RCA counters to map relevant groupings of correlated anomalous KPIs with a set of related RCA counters aligned with a preferred performance outcome.

12. The network node (11) according to claim 10, wherein the network node is configured to classify the multivariate data by:
providing feedback to the statistical analysing until a detection rate crosses or reaches a threshold set by an operator.

13. The method according to claim 2, wherein obtaining (201) the KPIs comprises
detecting anomalous KPIs over one or more time periods;
statistically analysing one or more clusters of detected anomalous KPIs, by analysing anomalous behavior pattern of the detected anomalous KPIs;
filtering the one or more clusters with root cause analysis, RCA, counter values and KPIs above thresholds to identify RCA counters of the KPIs.

14. The method according to claim 4, wherein classifying (202) the multivariate data comprises
providing feedback to the statistical analysing until a detection rate crosses or reaches a threshold set by an operator.

15. A computer program product comprising instructions, which, when executed on at least one processor, cause the at least one processor to carry out a method according to claim 2, as performed by the network node.

16. A computer-readable storage medium, having stored thereon a computer program product comprising instructions which, when executed on at least one processor, cause the at least one processor to carry out a method according to claim 2, as performed by the network node.

17. The network node (11) according to claim 9, wherein the network node is configured to obtain the KPIs by:
detecting anomalous KPIs over one or more time periods;
statistically analysing one or more clusters of detected anomalous KPIs, by analysing anomalous behavior pattern of the detected anomalous KPIs;
filtering the one or more clusters with root cause analysis, RCA, counter values and KPIs above thresholds to identify RCA counters of the KPIs.

18. The network node (11) according to claim 11, wherein the network node is configured to classify the multivariate data by:
providing feedback to the statistical analysing until a detection rate crosses or reaches a threshold set by an operator.
